(19) United States
(12) Patent Application Publication
(10) Pub. No.: US 2016/0068736 A1
(43) Pub. Date: Mar. 10, 2016

(54) REVERSIBLE FOAMED WELLBORE FLUIDS

(71) Applicant: M-I L.L.C., Houston, TX (US)

(72) Inventors: Guido De Stefano, Houston, TX (US); Emanuel Stamatakis, Houston, TX (US); Steven Young, Houston, TX (US)

(21) Appl. No.: 14/785,259

(22) PCT Filed: Apr. 16, 2014
(86) PCT No.: PCT/US2014/034258

§ 371 Date: Oct. 16, 2015

Related U.S. Application Data
(60) Provisional application No. 61/813,110, filed on Apr. 17, 2013.
(60) Provisional application No. 61/909,635, filed on Nov. 27, 2013.

(51) Int. Cl. C09K 8/38; E21B 21/14; E21B 43/25; C09K 8/94

(52) U.S. Cl. CPC C09K 8/38; C09K 8/94; E21B 21/14; E21B 43/255

(57) ABSTRACT

Compositions may include reversible foam fluids for wellbore and other applications, and methods of using the reversible foamed fluid may include contacting a foamed fluid with a foam deactivator to dissolve the foam and produce a defoamed fluid; contacting the defoamed fluid with a foam reactivator; and generating a foamable fluid.

### RELATED APPLICATIONS

This application claims priority to and the benefit of U.S. Provisional Patent Application having Ser. No. 61/813,110, filed Apr. 17, 2013, and U.S. Provisional Patent Application having Ser. No. 61/909,635, filed Nov. 27, 2013, which both are incorporated herein by reference.

### BACKGROUND

During the drilling of a wellbore, various fluids are used in the well for a variety of functions. The fluids may be circulated through a drill pipe and drill bit into the wellbore and then may subsequently flow upward through wellbore to the surface. During this circulation, drilling fluids may act to lubricate and cool rotary drill bits, to prevent blowouts by providing hydrostatic pressure to balance any high-pressure formation fluids that may suddenly enter the wellbore, and to remove cuttings from the wellbore.

Wellbore fluids may also be used to provide sufficient hydrostatic pressure in the well to prevent the influx and efflux of formation fluids and wellbore fluids, respectively. When the pore pressure (the pressure in the formation pore space provided by the formation fluids) exceeds the pressure in the open wellbore, the formation fluids tend to flow from the formation into the open wellbore. Therefore, the pressure in the open wellbore may be maintained at a higher pressure than the pore pressure. While it is highly advantageous to maintain the wellbore pressures above the pore pressure, on the other hand, if the pressure exerted by the wellbore fluids exceeds the fracture resistance of the formation, a formation fracture and thus induced mud losses may occur. Further, with a formation fracture, when the wellbore fluid in the annulus flows into the fracture, the loss of wellbore fluid may cause the hydrostatic pressure in the wellbore to decrease, which may in turn also allow formation fluids to enter the wellbore. As a result, the formation fracture pressure may define an upper limit for allowable wellbore pressure in an open wellbore while the pore pressure defines a lower limit. Therefore, a major constraint on well design and selection of wellbore fluids is the balance between varying pore pressures and formation fracture pressures or fracture gradients though the depth of the well.

Accordingly, relatively intermediate-density or low-density compositions having corresponding intermediate or low hydrostatic pressure gradients may be employed to maintain control over downhole pressure for a selected wellbore operation. Low-density wellbore fluids may include gases, mists, and foams. Conventional foams may include a gas dispersed by a surfactant or foaming agent within an aqueous or oleaginous base fluid. The molecular structure of foaming agents often includes both a hydrophilic region and a hydrophobic region and due to the thermodynamic instability the foaming agents tend to gather at the interface of the base fluid and any other surrounding or enclosed phases. In the case of foam, the continuous phase is liquid, and the discontinuous phase is a gas. In general, foam represents stored mechanical energy, and without mechanical agitation a fluid containing a surfactant will not create a foam. Foams may be generated under mechanical agitation such as shearing or formed by injecting pressurized air (or another gas such as nitrogen, CO₂, or methane) into the fluid. Individual foam bubbles initially tend to assume a spherical configuration, but over time the base fluid and the surfactant will drain by gravity through the foam structure, thinning and weakening it (a process called creaming). It is often a characteristic of foams subject to gravity that over time they will tend to collapse or dissipate.

Foams suitable for wellbore applications may have small dense bubbles that resemble a thick shaving cream and be capable of suspending and transporting the suspended rock fragments out of the borehole. For example, foam drilling and downhole hammers have been used successfully in a vast number of applications involving drilling hard rock, shale, caliche and other very dense formations. During drilling operations, the foam lifts the cuttings and/or other particulate debris up through the wellbore.

However, problems can arise because an average drilling operation may generate one thousand cubic feet of foam per minute as the foam expands within the relatively low pressure of the wellhead. Disposal of mixed foam and drill cuttings may then require mechanical separation of drilling solids from the foam or the mixture may be sent to a settling pond or basin. Either approach may create unique environmental problems, require large and expensive vessels to contain the foam mixture, or both. For example, when employed to store dissipating foams, settling ponds are often be lined to prevent environmental damage from foamed fluid seepage into the earth and, further, winds may carry chemical-containing foams and spread contaminants. Mechanical separation of foams may also carry the difficulties associated with separating solids from the foamed wellbore fluid, which includes the costs attributed to the use of separators that are often expensive and require significant added amounts of work time and maintenance.

### SUMMARY

This summary is provided to introduce a selection of concepts that are further described below in the detailed description. This summary is not intended to identify key or essential features of the claimed subject matter, nor is it intended to be used as a n aid in limiting the scope of the claimed subject matter.

In one aspect, embodiments disclosed herein relate to methods of using a foamed wellbore fluid that may include circulating the foamed wellbore fluid through a wellbore; and contacting the foamed wellbore fluid with a foam deactivator to form a defoamed fluid.

In another aspect, methods described herein relate to using a reversible foamed fluid that may include contacting a foamed fluid with a foam deactivator to dissolve the foam to produce a defoamed fluid; contacting the defoamed fluid with a foam reactivator; and generating a foamable fluid.

In yet another aspect, embodiments described herein relate to reversible foaming wellbore fluid compositions that may include a base fluid; a foaming agent; and a rheological modifier.

Other aspects and advantages of the embodiments disclosed herein will be apparent from the following description and the appended claims.

### BRIEF DESCRIPTION OF DRAWINGS

FIG. 1 is an illustration of a concentration curve for a reversible foam composition in accordance with embodiments described herein.

FIG. 2 is an illustration of repeated foaming cycles for a reversible foam composition in accordance with embodiments described herein.

FIG. 3 is an illustration of a concentration curve for a reversible foam composition in accordance with embodiments described herein.

FIGS. 4 and 5 are illustrations of the amount of foam generated from embodiments of reversible foam compositions of the present disclosure as a function of an added rheological modifier.

### DETAILED DESCRIPTION

In one aspect, embodiments disclosed herein relate to foaming compositions that may be used for wellbore operations such as drilling, workover, completions, etc. While low-density foams may be used in a number of operations, controlling foamed fluids at the surface may be problematic and often requires complete disposal of all fluid returning from a well. This may, in turn, necessitate continuous production of new foam to sustain operation. In one or more embodiments, foamed wellbore fluids may have controllable density for low pressure formations, while being breakable (collapsible) to aid in handling. Further, the foamed fluids of the present disclosure may be reversible, meaning that a generated foam may be treated with a foam deactivator to reduce or eliminate the gas discontinuous phase and reduce the overall volume of the remaining fluid, and then treated with a foam reactivator at some later time when the fluid is to be refoamed and reused. In some embodiments, the addition of the deactivator and reactivator may be cycled multiple times, enabling the wellbore fluid to be reused by collapsing the foam, collecting the remaining fluid, and adding a foam reactivator when a foamed fluid is needed again.

Foamed wellbore fluids in accordance with the present disclosure include a discontinuous gas phase, a foaming agent, and a continuous aqueous phase. Formation of foam may be achieved by mixing a foaming agent into a provided based fluid and then introducing air into the fluid by mechanical agitation or direct injection of gases such as compressed air, nitrogen, carbon dioxide, natural gases, etc. Foamed wellbore fluids may be generated at the surface, during pumping of the fluid downhole, or in situ once emplaced downhole. Foamed wellbore compositions can be continuously injected or batch treated into a drilling-fluid stream. As the foam fluid returns to the surface, the foam may be recirculated or defoamed by contacting the foam with a foam deactivator. Once a wellbore fluid has been defoamed, the fluid may be disposed of, stored for later use in some embodiments, or contacted with a foam reactivator and refoamed in other embodiments.

When formulated as a drilling fluid, foamed wellbore fluids of the present disclosure may possess lubricating properties suitable for use with conventional foam drill bits and downhole hammers. Drilling foams may contain an aqueous base fluid containing air or gas bubbles, much like shaving foam, and withstand high salinity, hard water, solids, entrained oil, and elevated temperatures. In addition, foamed wellbore fluids of the present disclosure may be reversible, allowing an operator to collapse or break the foam to release the discontinuous gas phase. For example, the foamed wellbore fluid may be collapsed as the foam returns to the surface from the well, or is collapsed in the well and pumped to the surface. Once collapsed, base fluid and surfactant may be removed from the drill site along with any suspended cuttings. In some embodiments, the collapsed fluid may be contacted with a material or fluid that reactivates the surfactant, which then allows the fluid to be refoamed prior to or after being reintroduced downhole.

In another embodiment, foam wellbore fluids in accordance with the present disclosure may be used in the repair or stimulation of an existing production well for the purpose of restoring, prolonging, or enhancing the production of hydrocarbons. In enhanced oil recovery processes, a foamed wellbore fluid may be emplaced into an injection well to improve the sweep efficiency of a driving fluid through the reservoir into neighboring wells. Foamed fluids may be generated either in the reservoir pore space or at the surface before injection. The foam serves to physically block the volumes through which the steam is shortcutting and divert the flow of the steam into unswept portions of the formation. Foam flooding may mitigate sweep heterogeneities, including those caused by loss of fluids to regions of higher permeability or those caused by gravity override.

In other embodiments, foam wellbore fluids of the present disclosure may be formulated as workover fluids. As known in the art, workover applications are processes of performing major maintenance or remedial treatments on an oil or gas well. In many cases, workover implies the removal and replacement of the production tubing string after the well has been killed and a workover rig has been placed on location. Through-tubing workover operations, using coiled tubing, snubbing or slickline equipment, are routinely conducted to complete treatments or well service activities that avoid a full workover where the tubing is removed. These operations may save considerable time and expense. The foamed fluids of the present disclosure may also be emplaced in the wellbore, in contact with the reservoir, while workover operations are conducted.

Foam wellbore fluids of the present disclosure may be prepared by adding a foaming agent to a wellbore fluid and then generating a foamed fluid by shearing the wellbore fluid and/or injecting a gas to form a foamed wellbore fluid. Using methods described herein the foamed fluid may then be collapsed through the addition of a foam deactivator that is contacted with the foam in solid form or solubilized in a suitable solvent. After the foam wellbore fluid is collapsed, the foaming agent that has been sequestered or otherwise deactivated may be reactivated by the addition of a foam reactivator to the defoamed fluid, wherein the foam reactivator may be added as a solid or solubilzed in a suitable solvent.

Foaming Agents

Foaming agents in accordance with the present disclosure are additives used in preparation of foam wellbore fluids. Foaming agents in accordance with the present disclosure may be anionic or zwitterionic surfactants that may be either small molecules or polymers. When present within a foamed wellbore fluid, surfactants may increase the formation of a foam and stabilize the structure of the constituent cells.

In one or more embodiments, the foaming agent may be an anionic surfactant. Examples of foaming anionic surfactants which may be employed may have the general formula: R₁XR₂, where R₁ is a hydrophobic chain containing 3 to 20 carbons that may be linear, branched, saturated, unsaturated, contain aromatic groups, or combinations thereof, X is a sulfate or an isostere thereof including nitrate esters, carboxylic acids, phosphates, and the like, and R₂ is hydrogen or a counterion produced from an alkali or alkaline metal, ammonium, or tetraalkyl ammonium. Other examples of foaming agents may include alkane sulphonic acids, linear alpha-olefin sulphonic acids (AOS), alkyl sulfates, alkyl sulfonates, alkyl sulfosuccinate, dialkyl sulfosuccinate, alkoxylated alkyl sulfonates, methyl ester sulfonates, alkyl carboxylates, fatty acids, fatty acid alkanolamide, alkyl sarcosinates, and the like.

In yet other embodiments, the anionic surfactant may be represented by the chemical formula: R₁CON(R₂)CH₂XR₃ wherein R₁ is a hydrophobic chain having about 12 to about 24 carbon atoms, R₂ is hydrogen, methyl, ethyl, propyl, or butyl, and X is carboxyl, phosphoryl, or sulfonyl, and R₃ is hydrogen or a counterion produced from an alkali or alkaline metal, ammonium, or tetraalkyl ammonium. The hydrophobic chain can be an alkyl group, an aromatic group, an alkenyl group, an alkyl, an arylalkyl, or an alkoxyalkyl group. Examples of a hydrophobic chain include a tetradecyl group, a hexadecyl group, an octadecentyl group, an octadecyl group, and a docosenoic group.

In one or more embodiments, at least one foaming agent may be incorporated at a percent by weight (wt %) that may range from any lower limit selected from the group of 0.1 wt %, 0.3 wt %, 0.5 wt %, 0.75 wt %, and 1 wt % to any upper limit selected from the group of 0.5 wt %, 1%, 2 wt %, 2.5 wt %, and 3.5 wt %.

Base Fluid

Foamed wellbore fluids of the present disclosure may be formulated using any of the above described foaming agents dispersed throughout a base fluid. The base fluids may contain an aqueous fluid such as at least one of fresh water, sea water, brine, mixtures of water and water-soluble organic compounds and mixtures thereof that forms the continuous phase of the fluid. In one or more embodiments, the fluid may be substantially free of an oleaginous fluid. For example, a foamed wellbore fluid may be formulated with mixtures of desired salts in fresh water. Such salts may include, but are not limited to alkali metal chlorides, hydroxides, or carboxylates, for example.

In various embodiments, the base fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used as base fluids disclosed herein may be natural or synthetic, with synthetic brines tending to be much simpler in constitution. In one embodiment, the density of a foamed wellbore fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Once formulated from a foaming agent and a base fluid, foam wellbore fluids of the present disclosure may also exhibit temperature stability up to 150° F. in some embodiments, or greater that 150° F. in other embodiments. In one or more embodiments, foam wellbore fluids may possess an overall fluid density that ranges from a lower range selected from the group of 0.1, 0.2, 0.3, and 0.4 ppg, to an upper range selected from the group of 0.4, 0.5, 0.6, 0.7, 0.8, and 1 ppg.

Foam Deactivators

Once emplaced within a wellbore, foamed wellbore fluids may expand considerably, resulting in the return of large volumes of foam to the surface. In order to reduce the overall volume of the foam, a foam deactivator may be added that binds or otherwise interferes with the foaming agent used to stabilize the foam. While cationic or anionic foaming agents may be deactivated by adding an acid or base to alter solubility by modifying the ionization state of the foaming agent, this approach carries the considerable risk to operators because of the dangers associated with handling strong acids and bases. Further, the presence of pH modifying compounds downhole reduces the effectiveness and reliability of this approach, because naturally occurring pH fluctuations may result in unexpected increases or decreases in foam production, which may, in turn, hinder the foam-based wellbore operation.

In one or more embodiments, a foamed wellbore fluid in accordance with the instant disclosure may be contacted with a foam deactivator that disrupts the stabilized foam through electrostatic interactions with the foaming agent, which results in the formation of inactivated foaming agent/foam deactivator complex. Foam deactivators useful in embodiments disclosed herein are chemical additives used to accelerate creaming and the removal of the gaseous phase from the wellbore fluids, referred to herein equivalently as deactivating or “breaking” foams, as the fluids are returned from the wellbore following a wellbore operation. Foam deactivation may be done in preparation for disposal of the fluids or the regeneration of foam at a later time in other embodiments. In some embodiments, the foam wellbore fluid may be broken with a foam deactivator that is injected at the surface or within the wellbore or as the foam returns to a mud pit after it exits the borehole. Once the foam has been disrupted, the remaining defoamed fluid may be disposed of, transported, or stored for later use.

One way that foam deactivation may be achieved is by complexing the foaming agent with a polyvalent cation or anion (depending on the charge of the respective foaming agent used). In one or more embodiments, the foam deactivator may be selected from alkaline earth metals including magnesium, calcium, barium, strontium, and the like in the form of salts, oxides, etc. In other embodiments, the foam deactivator may be selected from polyvalent cations such as zirconium, silver, zinc, iron, aluminum, and the like. For example, in one or more embodiments, the foam deactivator may be selected from divalent cationic salts including calcium halides, magnesium halides, calcium chloride, magnesium chloride, calcium oxide, and magnesium oxide.

In one or more embodiments, the foam deactivator may be incorporated at a percent by weight (wt %) that may range from any lower limit selected from the group of 0.1 wt %, 0.5 wt %, 1 wt %, and 2 wt % to any upper limit selected from the group of 0.75 wt %, 1.0 wt %, 1.5%, 2 wt %, 3 wt %, and 5 wt %. In other embodiments of the present disclosure, the foam deactivator may be added to a foamed wellbore fluid in a ratio that ranges from about 10:1 foam deactivator to foaming agent, to about 30:1 foam deactivator to foaming agent.

Foam Reactivators

If desired, the foam may be regenerated by contacting the defoamed fluid with a foam reactivator that counteracts the effects of the foam deactivator. In one or more embodiments, foam reactivators may function by a number of chemical mechanisms that include disrupting a complex formed between a foaming agent and foam deactivator. For example, the foam reactivator may be a salt that complexes with the foam deactivator, which increases the solubility of the foaming agent and/or otherwise reactivates the ability of the foaming agent to stabilize or produce foams.

In embodiments in which the deactivated foaming agent is an anionic surfactant complexed with a divalent cation, the foam reactivator may be an anion that competes with the surfactant for the divalent cation or, in some embodiments, forms an insoluble salt complex with the foam deactivator. For example, the reactivator may be selected from a salt of one or more polyvalent anions that include sulfonates, carbonates, phosphates, nitrites, nitrates, and the like. The selected anions may be delivered to the fluid in the form of a salt of any of the above listed anions with an alkali metal or alkaline metal derived cation, which may include, for example, carbonate salts such as sodium carbonate, potassium carbonate, or sulfonate salts such as sodium sulfonate, potassium sulfonate, and the like.

In other embodiments, the foam reactivator may be a chelant that is added to bind and sequester the foam deactivator. For example, when foam deactivator forms an insoluble complex with a foaming agent, a chelant may be used to bind the foam deactivator (through anionic or cationic exchange) and release the foaming agent into the surrounding solution. Solubilized foaming agents may then be activated by shearing the wellbore fluid and/or injecting a gas to form a foamed wellbore fluid.

Chelants that may be used as foam reactivators in accordance with the embodiments disclosed herein may sequester foam deactivators such as polyvalent cations through electrostatic interactions with one or more functional groups present on the chelant. Useful chelants may include organic ligands such as ethylenediamine, diaminopropane, diaminobutane, diethylenetriamine, triethylenetetraamine, tetraethylenepentamine, pentaethylenehexamine, tris(aminoethyl)amine, triaminopropane, diaminoaminoethylpropane, diaminomethylpropane, diaminodimethylbutane, bipyridine, dipyridylamine, phenanthroline, aminoethylpyridine, terpyridine, biguanide and pyridine aldazine.

In some embodiments, the foam reactivator may be a polydentate chelator that forms multiple bonds with the complexed metal ion. Polydentate chelants suitable for use as foam reactivators may include, for example, ethylenediaminetetraacetic acid (EDTA), diethylenetriaminepentaacetic acid (DTPA), citric acid, nitrilotriacetic acid (NTA), ethylene glycol-bis(2-aminoethyl)-N,N,N′,N′-tetraacetic acid (EGTA), 1,2-bis(o-aminophenoxy)ethane-N,N,N′,N′-tetraaceticacid (BAPTA), cyclohexanediaminetetraacetic acid (CDTA), triethylenetetraaminehexaacetic acid (TTHA), N-(2-Hydroxyethyl)ethylenediamine-N,N′,N′-triacetic acid (HEDTA), glutamic-N,N-diacetic acid (GLDA), ethylene-diamine tetra-methylene sulfonic acid (EDTMS), diethylene-triamine penta-methylene sulfonic acid (DETPMS), amino tri-methylene sulfonic acid (ATMS), ethylene-diamine tetra-methylene phosphonic acid (EDTMP), diethylene-triamine penta-methylene phosphonic acid (DETPMP), amino tri-methylene phosphonic acid (ATMP), salts thereof, and mixtures thereof. In one or more embodiments, the foam reactivator may be D-SOLVER™ HD, which is commercially available from M-I L.L.C. (Houston, Tex.). However, this list is not intended to have any limitation on the foam reactivators suitable for use in the embodiments disclosed herein. One of ordinary skill in the art would recognize that selection of the chelant used as a foam reactivator may depend on the metals present downhole in the filtercake. In particular, the selection of the foam reactivator may be related to the specificity of the chelant to the particular cations, the logK value, the optimum pH for sequestering, and the commercial availability of the chelating agent, as well as downhole conditions, etc.

In one or more embodiments, the foam reactivator may be added to a defoamed wellbore fluid at a percent by weight (wt %) that may range from any lower limit selected from the group of 0.1 wt %, 0.5 wt %, 1 wt %, and 2 wt % to any upper limit selected from the group of 0.75 wt %, 1.0 wt %, 1.5%, 2 wt %, 3 wt %, and 5 wt %. In other embodiments of the present disclosure, the foam reactivator may be added to a foamed wellbore fluid in a ratio that ranges from about 5:1 foam reactivator to foaming agent, to about 20:1 foam reactivator to foaming agent.

Additives

In one or more embodiments, a rheological modifier may be added to increase the durability of the foam by stabilizing the foam cells. In some embodiments, the rheological modifier may be selected from viscosifying agents, such as polymeric viscosifiers, that may increase foam stability and stiffness of the formed foams, which may in turn the density of the foam and the carrying capacity. Examples of suitable viscosifying agents may also include partially hydrolyzed polyacrylamide (PHPA), biopolymers (such as guar gum, starch, xanthan gum and the like), bentonite, attapulgite, sepiolite, polyamide resins, polyanionic carboxymethylcellulose (PAC or CMC), polyacrylates, lignosulfonates, as well as other water soluble polymers. In particular embodiments, the viscosifying agent may be POLYPLUS™ RD, an acrylic copolymer available from M-I L.L.C. (Houston, Tex.).

In embodiments, foam wellbore fluids may contain a rheological modifier incorporated at a percent by weight (wt %) that may range from any lower limit selected from the group of 0.1 wt %, 0.3 wt %, 0.5 wt %, 1 wt %, 2 wt %, and 5 wt % to an upper limit selected from the group of 1 wt %, 5 wt %, 10 wt %, 20 wt % and 30 wt %.

The components of the foamed fluid composition can be added individually to a base fluid in any desired order, or mixed together and added as a mixture to the base fluid. The foamed wellbore fluid can be premixed at the surface or the components and base fluid injected down the well separately in any desired order, or in any desired combination, whereupon the foaming agent composition forms as the components pass down the well and mix. Optionally, other ingredients such as corrosion inhibitors and scale deposition inhibitors can be added to the foaming agent solution.

### EXAMPLES

The following examples are directed to an embodiment of a foamed wellbore fluid in accordance with the present disclosure. One of the unique aspects of the described system is the ability to collapse and subsequently regenerate the foam through the addition of a foam deactivator followed by the subsequent addition of a foam reactivator. Another unique aspect shown below includes the ability to perform multiple foaming cycles with the same fluid. In an exemplary embodiment, the system may utilize an aqueous base fluid containing a sulfonated anionic surfactant (for example, AOS) and an optional viscosifying agent. When creation of foam is desired, the fluid composition is sheared or otherwise mechanically agitated to introduce a discontinuous gas phase. In order to collapse the foam a deactivator is added to form an inactive complex with the surfactant. In this exemplary embodiment, the foam deactivator is divalent calcium provided from an added calcium chloride brine. The foamed wellbore fluid may be reformed through the addition of a foam reactivator that sequesters the calcium and releases the surfactant, followed by mechanical agitation or gas injection to create the gaseous discontinuous phase. In the examples presented below, the foam reactivator is a carbonate salt that forms an insoluble, non-toxic precipitate of calcium carbonate with the divalent calcium foam deactivator.

### Example 1

### Foam Height as a Function of Added Foaming Deactivator

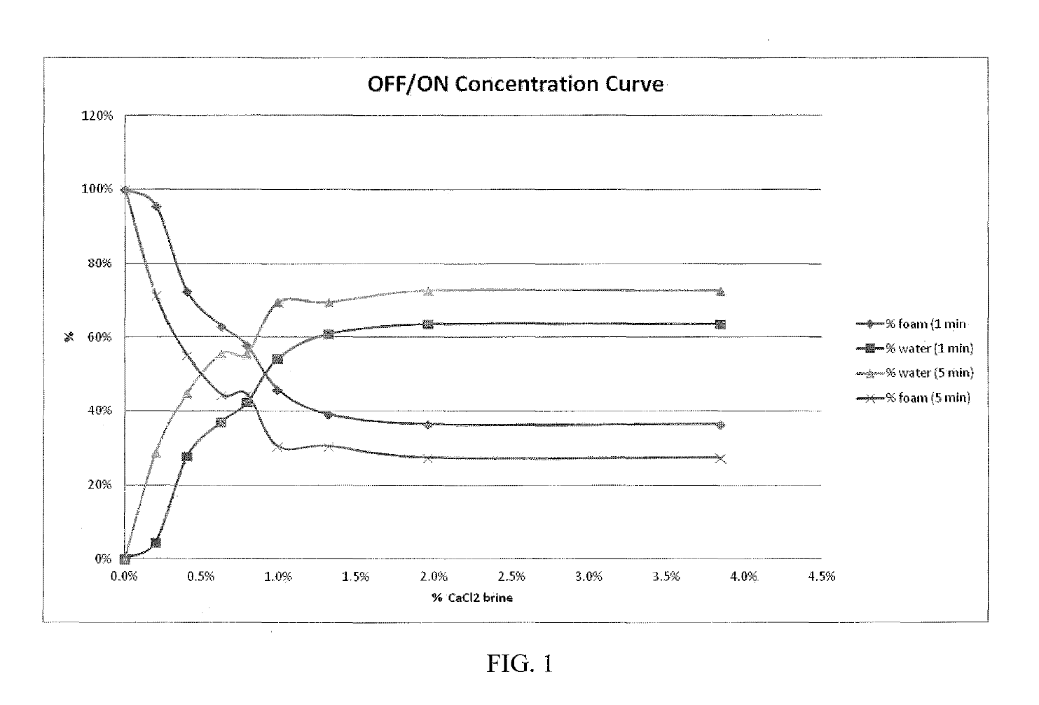

A foamed wellbore fluid was prepared from a water base fluid, AOS, and varying concentrations of calcium chloride brine as the foam deactivator. The components were mixed in a graduated cylinder equipped with an mixer and adapter to dock the cylinder to a commercial blender. In order to prepare the foam, the mixture was placed in the cylinder and sheared for 45 seconds to generate the foam. Following shearing, the height of the foam column was measured at 1 minute and 5 minute time points. The addition of 3.6 grams of solid calcium chloride was used as a foam deactivator to “turn off” or collapse the foam. The resulting fluid was then sheared for 15 seconds and the foam height was measured again at 1 minute and 5 minutes. Results for each concentration point are plotted in FIG. 1, where height of the foam is normalized to the height of the foam column in the absence of the foam deactivator.

### Example 2

### Reversible Cycling of Foam Wellbore Fluids

In a second experiment to study the reversibility of foam generation, a cylinder was charged with 150 grams of water with 0.5 grams of an AOS foaming agent and then mixed at high shear for 45 seconds to generate a foam. To “turn off” the foam, 3.6 grams of solid calcium chloride foam deactivator was then added, the resulting fluid composition was sheared for 15 seconds, and the foam height was measured again at 1 minute and at 5 minutes. To “turn on” the foam, 1.8 grams of solid sodium carbonate foam reactivator was added to complex and precipitate the calcium as calcium carbonate, regenerating the soluble surfactant.

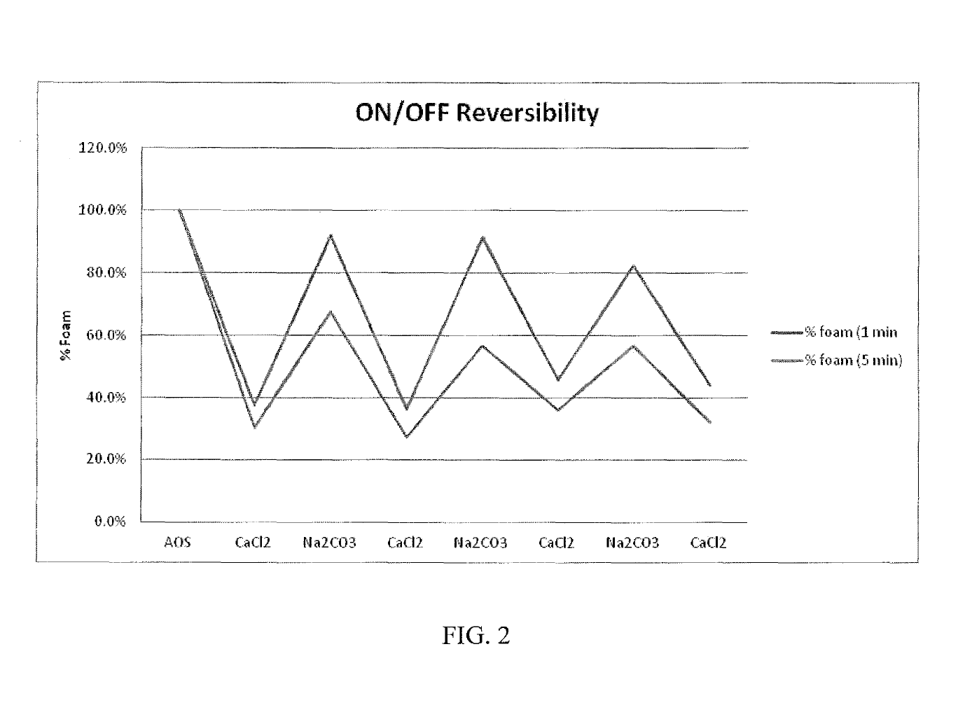

The regenerated foam composition was then mixed at high shear for 40 seconds and the foam height was again measured at 1 minute and 5 minute time points. The deactivator/reactivator cycle was repeated three times. Results are plotted in FIG. 2, where height of the foam is normalized to the maximum height measured for the foam column.

### Example 3

### Effect of Viscosifying Agents on Reversible Foam Wellbore Fluids

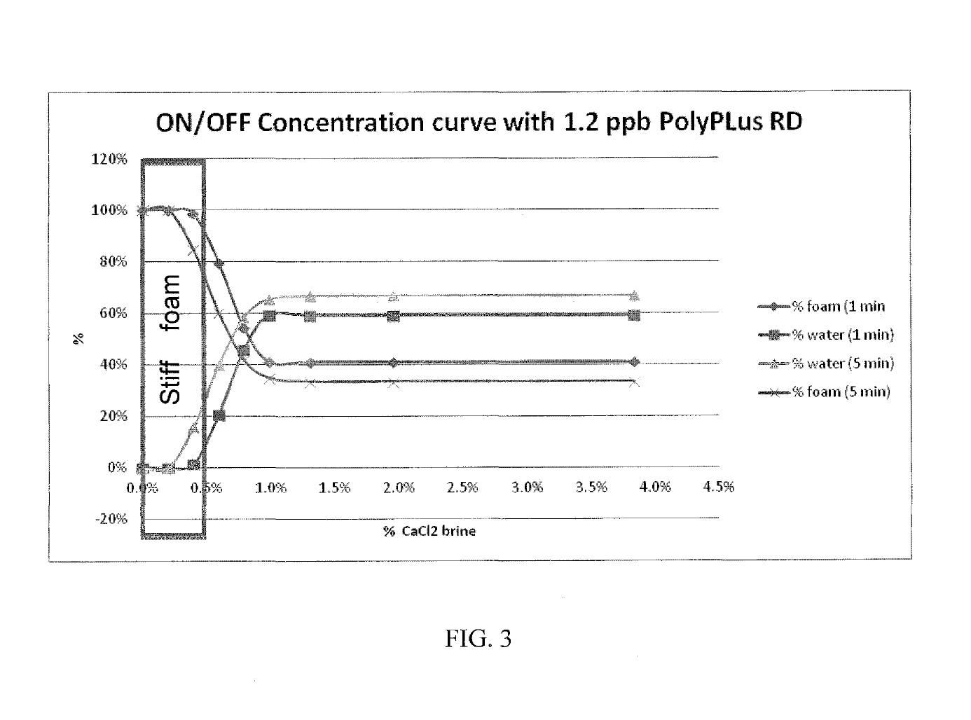

A formulation containing 150 mL of water, 0.5 g of AOS, and 0.5 g of POLYPLUS™ RD, a polymeric viscosifying agent available from M-I L.L.C. (Houston, Tex.) were admixed and sheared to form a foam. The addition of 3.6 grams of solid calcium chloride was used as a foam deactivator to remove the foam. The resulting fluid was again mixed at high shear for 15 seconds and the foam height was measured again at 1 minute and at 5 minutes. The results were plotted in FIG. 3, where the heights of the foam and water phases were individually compared as a function of added calcium chloride brine.

### Example 4

### Effect of Simulated Cutting Contamination on the Reversibility of Foam Wellbore Fluids

A foam wellbore fluid formulation was prepared by admixing 150 mL of water, 0.5 g of AOS, and 0.5 g of POLYPLUS™ RD, a polymeric viscosifying agent available from M-I L.L.C. (Houston, Tex.) and then shearing the combined components to form foam. To simulate contamination of the foamed wellbore fluid with cuttings and debris, increasing concentrations of Arne clay were added to the formulation. After addition of the Arne clay, the height of the foam was measured as an indicator of the foam resistance. The percent by weight of each of the components of the fluid composition calculated during the incremental addition of Arne clay is shown below in Table 1.

TABLE 1
Composition of sample assayed in Example 3.

| Water | AOS | POLYPLUS | Arne Powder | Total |
|---|---|---|---|---|
| (wt %) | (wt %) | (wt %) | (wt %) | (wt %) |
| 99.3 | 0.3 | 0.3 | 0.0 | 100 |
| 98.7 | 0.3 | 0.3 | 0.7 | 100 |
| 96.2 | 0.3 | 0.3 | 3.2 | 100 |
| 93.2 | 0.3 | 0.3 | 6.2 | 100 |
| 90.4 | 0.3 | 0.3 | 9.0 | 100 |
| 87.7 | 0.3 | 0.3 | 11.7 | 100 |
| 82.9 | 0.3 | 0.3 | 16.6 | 100 |
| 78.5 | 0.3 | 0.3 | 20.9 | 100 |

The foam height was recorded after each successive addition. Once the Arne powder was added to 21 wt % (w/w) more surfactant and water was added to compensate for the surfactant absorbed from the hydrated Arne clay. The foamed wellbore fluid was then cycled through treatment with 3.6 grams of calcium chloride foam deactivator and 1.8 grams of sodium carbonate foam reactivator.

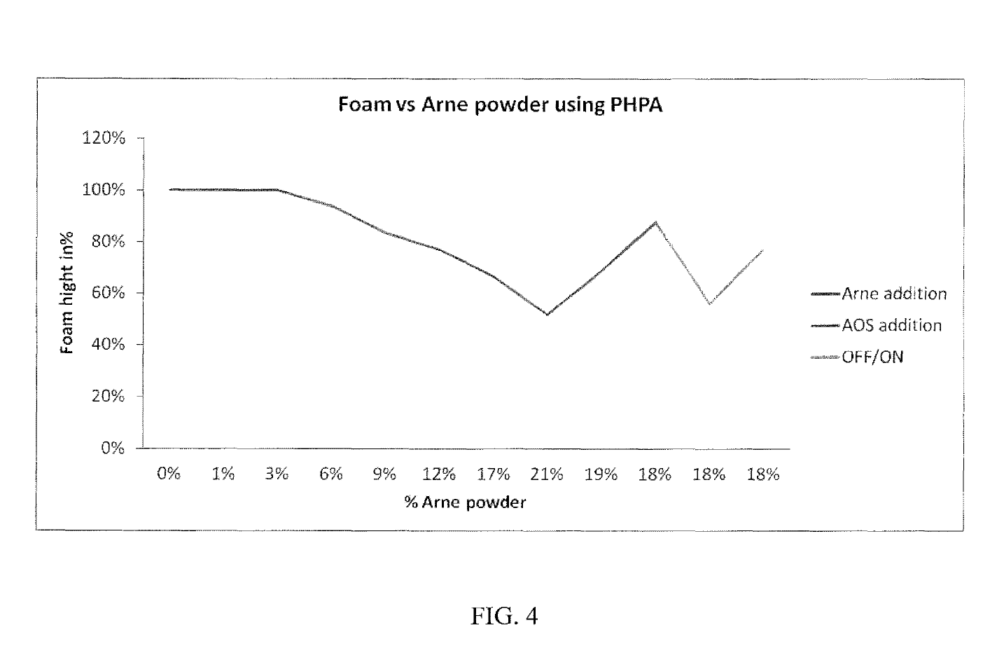

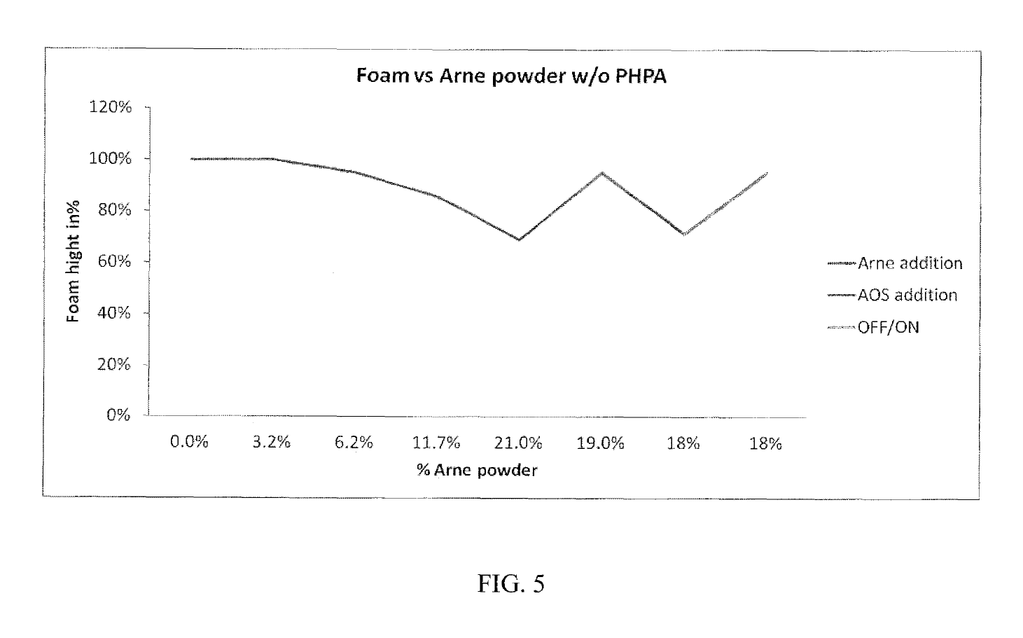

Results are shown in FIG. 4. The series was repeated substantially as described above, but without the addition of the viscosifying agent. Results are shown in FIG. 5.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims. Moreover, embodiments described herein may be practiced in the absence of any element that is not specifically disclosed herein.

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A method comprising:
circulating a foamed wellbore fluid through a wellbore; and
contacting the foamed wellbore fluid with a foam deactivator to form a defoamed fluid.

2. The method of claim 1, wherein the foamed wellbore fluid comprises a base fluid and a foaming agent.

3. The method of claim 1, further comprising contacting a foamable wellbore fluid with a gas to form the foamed wellbore fluid.

4. The method of claim 3, wherein contacting a foamable wellbore fluid with a gas to form a foamed wellbore fluid is done in situ within the wellbore.

5. The method of claim 1, further comprising disposing of the defoamed fluid.

6. The method of claim 1, further comprising contacting the defoamed fluid with a foam deactivator to form a foamable wellbore fluid.

7. The method of claim 1, wherein the foaming agent comprises an anionic surfactant.

8. The method of claim 1, wherein the foaming agent comprises an alpha-olefin sulfonic acid or salt thereof.

9. The method of claim 1, wherein the foam deactivator comprises a divalent cation.

10. The method of claim 1, wherein the foamed wellbore fluid further comprises at least one rheological modifier.

11. The method of claim 1, further comprising injecting the foamed wellbore fluid through a drill string and returning the foamed wellbore fluid to the surface, the returned foamed wellbore fluid comprising drill cuttings removed from the wellbore.

12. The method of claim 1, further comprising performing one or more workover operations.

13. The method of claim 1, further comprising stimulating the wellbore for enhanced oil recovery.

14. A method comprising:
contacting a foamed fluid with a foam deactivator to dissolve the foam and produce a defoamed fluid;
contacting the defoamed fluid with a foam reactivator; and
generating a foamable fluid.

15. The method of claim 14, further comprising generating a foamed fluid from the foamable fluid.

16. The method of claim 14, wherein the foamed fluid comprises a base fluid and a foaming agent.

17. The method of claim 14, wherein the foamed fluid is produced by contacting a foamable fluid with a gas to form the foamed fluid.

18. The method of claim 14, wherein contacting the foam with the foam deactivator precipitates at least a portion of the foaming agent.

19. The method of claim 14, wherein contacting the defoamed fluid with the foam reactivator solubilizes at least a portion of the foaming agent.

20. The method of claim 14, wherein the foam deactivator comprises a divalent cation.

21. The method of claim 14, wherein the foam reactivator comprises a salt that complexes the foam deactivator.

22. The method of claim 14, wherein the foam reactivator comprises a chelant.

23. The method of claim 14, wherein the wellbore fluid further comprises at least one of a viscosifying agent and a rheological modifier.

24. A wellbore fluid comprising:
a base fluid;
a foaming agent; and
a rheological modifier at a concentration that ranges from 1-5 wt %.

25. The wellbore fluid of claim 24, wherein the foaming agent comprises an anionic surfactant.

26. The wellbore fluid of claim 24, wherein the foaming agent comprises one or more anionic surfactants of the general formula: R₁XR₂, where R₁ is a hydrophobic chain containing 3 to 20 carbons that may be linear, branched, saturated, unsaturated, or combinations thereof, X is a sulfate, a nitrate ester, a carboxylic acid, or a phosphate, and R₂ is hydrogen, or a counterion produced from an alkali or alkaline metal, ammonium, or tetraalkyl ammonium.
